(19) United States
(12) Patent Application Publication
(10) Pub. No.: US 2022/0388571 A1
(43) Pub. Date: Dec. 8, 2022

(54) Steering Apparatus for Object Transporting Vehicles

(71) Applicant: Ezetrolley Pty Lyfd, Elwood (AU)

(72) Inventor: Jason Hartcup, Elwood (AU)

(21) Appl. No.: 17/770,282

(22) PCT Filed: Oct. 27, 2020
(86) PCT No.: PCT/IB2020/060039

§ 371 Date: Apr. 19, 2022

(30) Foreign Application Priority Data
Oct. 28, 2019 (AU) 2019904053

(51) Int. Cl. B62D 13/00; B60L 50/60; B62D 21/00

(52) U.S. Cl. CPC B62D 13/00; B60L 50/60; B62D 21/00

(57) ABSTRACT

The present invention provides apparatus for transporting materials, preferably large flat objects such as panes of glass, wood panels, paintings, and the like. The preferred embodiment includes a frame, an axle assembly, wheels, and a steering means, the steering means including track rods, a controlling means for controlling the steering means, the controlling means being pivotable about pivot points on the track rods. Preferably, the apparatus includes a tray or base plate for holding the materials being transported. Preferably, the controlling means is a tiller engageable with the pivot points. Preferably, the apparatus includes a handle for directing the frame. Preferably, the steering means includes a rotating bar. Preferably, the rotating bar engages a track rod. Preferably, the apparatus includes a motor for propulsion. Most preferably, the motor is electric, powered by a battery, particularly a rechargeable battery.

### TECHNICAL FIELD

The present invention relates to apparatus for steering and applications thereof, in particular object transporting vehicles.

### RELATED APPLICATION

This application claims the priority and benefit of Australian provisional application 2019904053 filed Oct. 28, 2019.

### BACKGROUND ART

Moving large and bulky materials from one place to another has always been problematic. Materials that are heavy cannot be carried and must be moved using a vehicle to bear the weight of the object. It is important for Occupational Health and Safety considerations that the weight of heavy materials are properly managed with appropriate equipment. Sometimes objects are large and flat, such as plates of glass, panels of wood, or other materials. Various solutions to the problem of transporting such materials have led to vehicles such as single-wheeled barrows or double-wheeled trolleys with frames of suitable shapes on which to rest an object while it is transported from place to another. Usually trolleys include an axle with a wheel fixed at each end. Such trolleys have limited ability to move and change direction so they can be difficult to direct through narrow and winding passages from one place to another.

### SUMMARY OF INVENTION

The invention provides apparatus for transporting materials, preferably large flat objects. Embodiments of the invention provide apparatus capable of being propelled in variable directions, turning, and stopping, all the while carrying objects. In one aspect, the invention includes a frame, an axle assembly, wheels, and a steering means, the steering means including a controlling means for controlling the steering means, the controlling means being pivotable about pivot points. Preferably, the steering means incorporate track rods that pivot about spaced pivot points on the controlling means. Preferably, the controlling means is a tiller engageable with the pivot points. Preferably, the apparatus includes a handle for directing the frame. Preferably, the steering means includes a rotating bar. Preferably, the rotating bar engages a track rod. Preferably, the apparatus includes a motor for propulsion. Most preferably, the motor is electric. Most preferably, the electricity is provided by a battery. Preferably, the battery is rechargeable. Preferably, the motor engages gears for rotating the axle to propel the apparatus. Preferably, the apparatus includes a base plate for holding the materials being transported.

### TECHNICAL PROBLEM

What is needed are more flexible steering systems incorporated in improved means for moving large and bulky materials through areas where movement is restricted.

### SOLUTION TO PROBLEM

The present invention provides a means for steering a carrying and transporting means, such as a trolley, the means incorporating a lever, such as a tiller, the lever incorporating two pivot points for pivoting engagement of a tie rod at each of the pivot points, the tie rods pivotable about the pivot points, and a wheel connected at the distal end of each of the tie rods. Each of the wheels is rotatable about its connection point. Embodiments of the invention may include motors, particularly, electric motors powered by batteries, for propulsion.

### ADVANTAGEOUS EFFECTS OF INVENTION

The invention most advantageously makes it possible to steer a carrying means to which the steering means is connected within a relatively small radius, which, in turn, makes it possible to move large or bulky objects carried in the carrying means within narrow confines and to steer the carrying means within the narrow confines while moving or propelling the carrying means from place to place. The invention is advantageously used in many applications. For example, the carrying means may be a trolley which may be used for moving large objects such as sheets of wood or glass along narrow corridors or likewise confined spaces. Further the invention provides a trolley which can stand at a fixed angle so that loaded material or object is kept in place. Another example is moving flat artworks such as paintings in galleries.

### BRIEF DESCRIPTION OF DRAWINGS

FIG. 1 shows an embodiment of the invention as a trolley incorporating a steering means with wheels orientated to allow movement in forward and backward directions.

FIG. 2 shows an embodiment of the invention as a trolley incorporating a steering means with wheels orientated to allow movement in sideways directions.

FIGS. 3A to 3D show the relative movement of elements of the steering mechanism in four different configurations of an embodiment of the invention.

FIG. 4 shows an embodiment of an axle and wheel assembly according to the invention.

FIGS. 5A to 5C shows different positions of an embodiment of the invention for carrying sheet materials.

FIGS. 6A to 6D show another embodiment of the invention with the steering mechanism in a different configuration.

FIGS. 7 and 8 show an embodiment of the invention incorporating a motor to propel the trolley.

### DESCRIPTION OF EMBODIMENTS

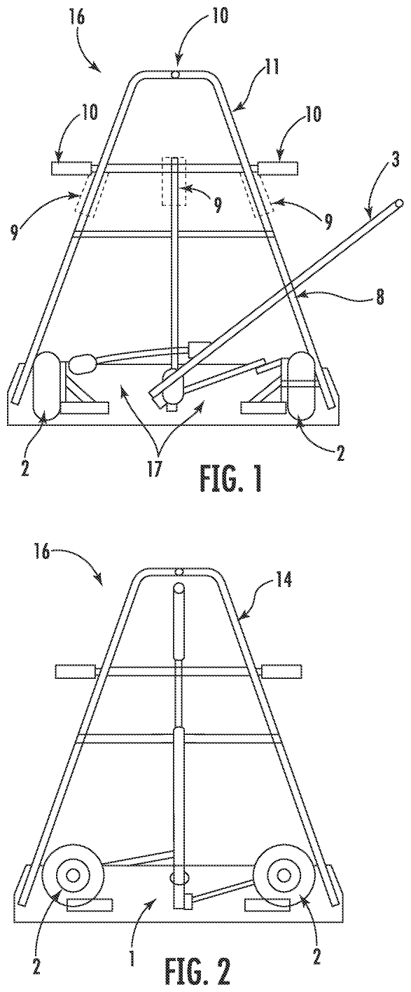

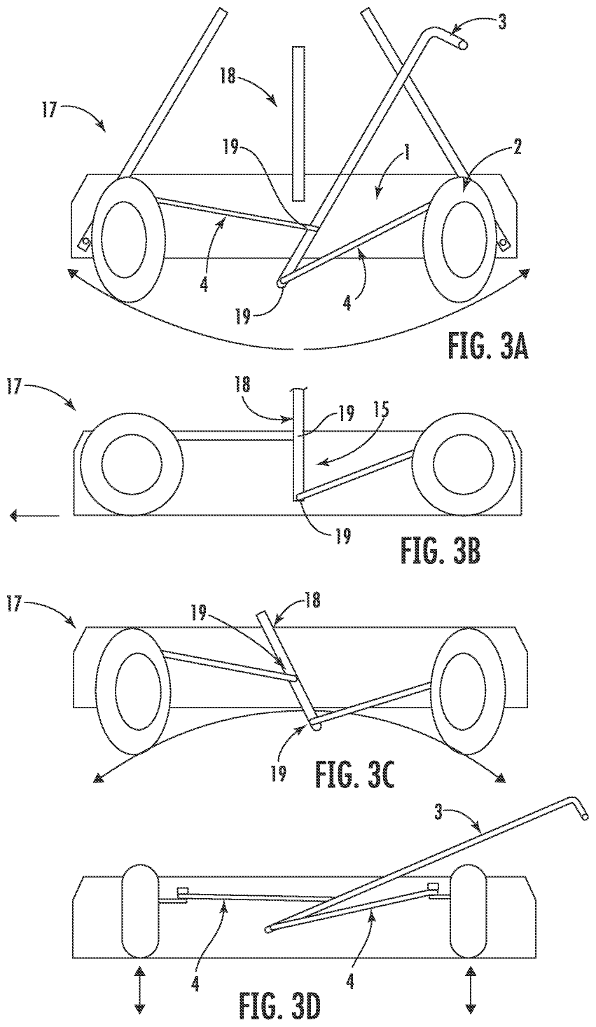

Embodiments of the invention are shown in FIGS. 1 to 8. The figures show an embodiment, being a trolley incorporating a steering means which enables the trolley to be easily manipulated through narrow passageways and rotated through small radii. It will be understood that the invention includes other types of applications of the steering means not illustrated herein and that the invention is limited only by the claims appended hereto. FIGS. 1 and 2 show a trolley 16 having a steering means 17 according to the invention. FIG. 1 shows the wheels 2 attached to the steering means 17 in a first orientation and FIG. 2 shows the wheels in a second orientation. The steering means 17 most advantageously enables the wheels to be oriented so the trolley 16 can be moved forward and backward direction as in FIG. 1 or in a sideways direction as in FIG. 2. The trolley 16 comprises of a main frame 11 of material having adequate strength to hold heavy materials. The figures show the elements of the frame to be angle in relation to the floor or ground, the angle being any suitable angle. The frame conveniently may incorporate one or more handles to enable easy direction of the trolley in multiple directions as enabled by the steering means 17 and attached wheels 2. The location and attachment of the handles can by varied. The steering means 17 may conveniently be controlled by controlling means 3. Preferably the controlling means 3 is a tiller arm or similar structure capable of controlling the steering means. The controlling means is moveable in multiple directions. Alternatively, the controlling means could be a mechanical or electrical means such as a motor or a linear actuator. FIG. 1 shows the controlling means 3 in a central or upright position. The frame 11 may incorporate a means 8 to hold the controlling means 3. Preferably the holding means 8 is a bracket with which the controlling means 3 is reversibly engageable. Other embodiments of the holding means 8 might be clip, for example. The holding means 8 provides a means to locking the controlling means 3 in order to position the wheels 2 in a way that the trolley 16 can be moved forward and backward. Preferably, the frame 11 forms an angle of about 100-110° with the surface on which it sits. FIG. 1 also shows handle 10 connected to mainframe 11 which provide a means to pull or push the trolley and to load it with materials.

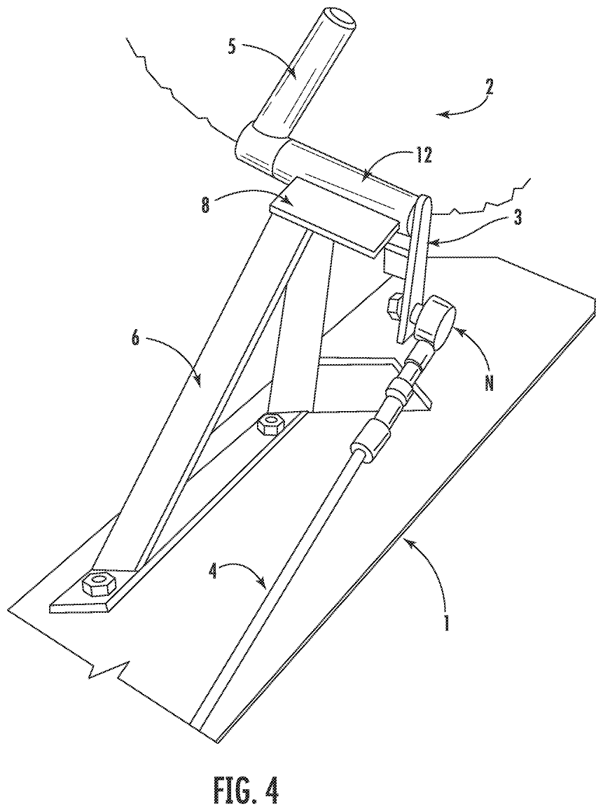

FIGS. 3A-3D show an embodiment of the steering means 17 according to the invention. Preferably, the steering means 17 comprises of a controlling means 3, track rods 4, pivotable about spaced pivot points 19 on the controlling means 3, each track rod 4 having a wheel 2 rotatable about its distal end. Preferably the controlling means takes the form of a tiller. FIG. 3A shows the wheels 2 locked in position for double-wheel steering, wherein the controlling means or tiller is positioned so that the trolley most advantageously can be rotated about a point thus enabling the trolley to be pushed either forward or backwards. It can be seen in FIG. 3 that the track rods 4 are held in position by the rotation of the tiller 3 about its pivot point 15 on the pivot rod 18. Movement of the pivot rod 18 about its pivot point 15 results in subsequent movement of the track rods 4 and attached wheels 2. Movement of the tiller from the position as shown in FIG. 3A where the wheels are locked in a first position to the tiller position shown as shown in FIG. 3C where the wheels are locked in a second position makes it possible to enable large flat objects carried with the trolley to be manoeuvred through narrow doorways and other narrow spaces.

The wheels can be locked in either position but the range of movement is variable between the two positions. The positioning of the tiller 3 in FIGS. 3A-3D shows the most advantageous control of the position of the wheels 2 of the trolley. For example, FIG. 3B shows the position of the wheels which allows the trolley 16 to be directed in a sideways direction, i.e. to the left or right in the Fig, when the tiller 3 is in a substantially vertical position. FIG. 3C shows the relative orientation of the tiller 3, track rods 4 and wheels for directing the movement of the trolley in forward or backward directions, i.e. into or out of the plane of the drawing.

The trolley 16 may incorporate a carrying means 1 for carrying materials. Preferably the carrying means is a tray as shown in FIG. 3. The tray is preferably fixed at an angle to the frame 11. Preferably, the angle is about 90 degrees. The angle of the tray 1 relative to the ground ranges between parallel with the ground surface to about 15 degrees when the tray 1 is loaded with materials and the frame is tilted for movement.

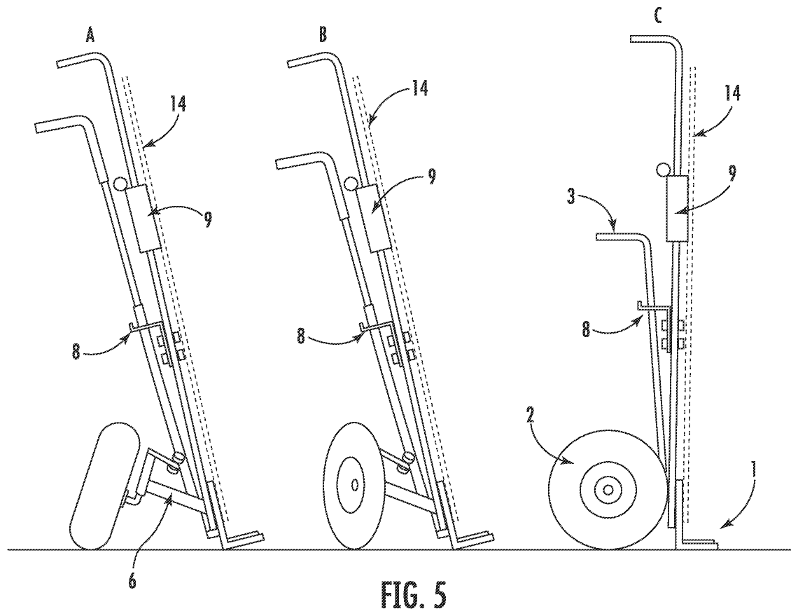

An embodiment of a wheel 2 and axle 5 assembly 6 according to the invention is shown in FIG. 4. An axle assembly 6 supports the wheel 2 (not shown) moving through an arc of up to around 135 degrees. There may be a kingpin 12 positioned at about 45 degrees to the carrying tray 1 for transporting materials. The wheel axle 5 is steered by the controlling means 3 as described above and shown as a tiller arm in this embodiment. The tiller arm is connected to a track rod 4. The track rod 4 may incorporate ball joints 7 at either end. The tiller arm 3 preferably rotates the kingpin 12. The axle assembly 6 may be connected to the carrying tray 1 with connection means. Preferably the connection means is a bolt. There may be a tiller steering stopping means 8 for when the trolley is to be moved in the forward or backward directions.

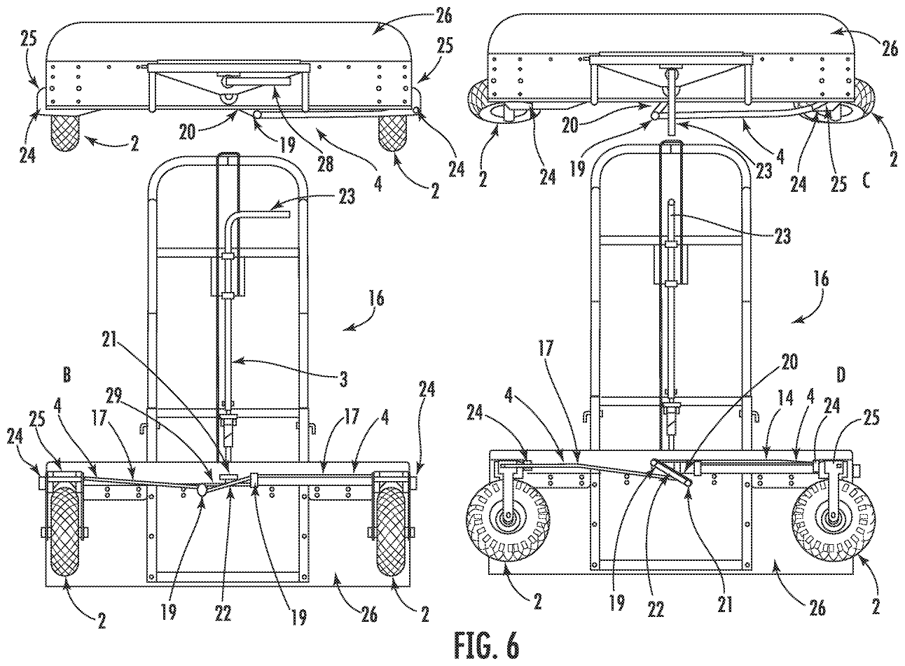

FIG. 5A to 5C show some different configurations of some of the elements of the invention such as the axle assembly, wheels, and main frame in an embodiment of the invention. FIG. 5B shows examples of the embodiment in perspective from one side. Where the tray 1 is oriented at an acute angle in respect to the ground. This orientation conveniently facilitates parking of sheet material, for example. In this example, sheet materials 14 could be leaning against the frame 11 during transport. FIG. 5A shows a wheel 2 angled so that the trolley 16 can be steered in a trajectory about 45 degrees sideways. The tray 1 conveniently is able to support sheet material 14, for example, in such a trajectory of movement of the trolley 16. This orientation of the wheels 2 and axle assembly 6 most conveniently enables movement of a trolley charged with a large, wide object to be directed through a narrow passageway such as a doorway or similarly narrow space. FIG. 5C shows the embodiment of the invention in a position where the tray 1 is flat on the ground and parallel with the ground. In this orientation the frame is generally at a right angle with the ground. FIG. 5C shows the orientation of the trolley when it would be in “stopped” position, with the tiller arm 3 in fixed position engaged with the stop bracket 8.

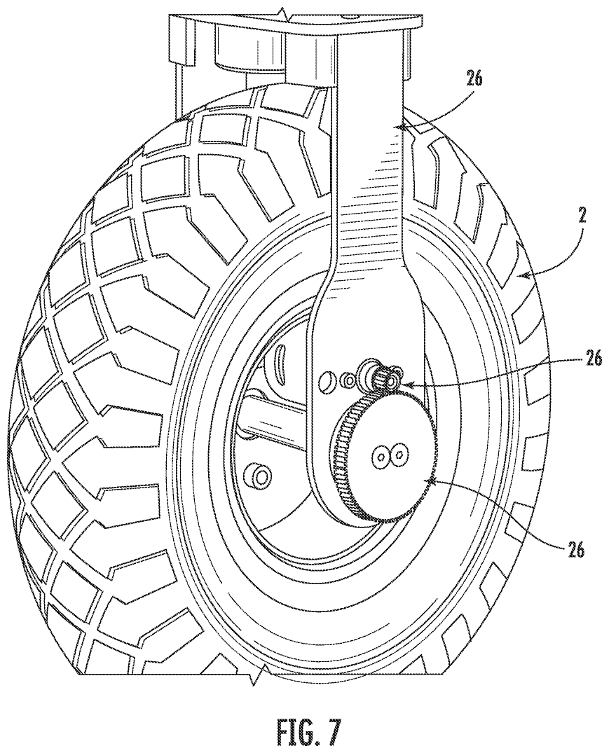

An alternative embodiment of the invention is shown in FIGS. 6A to 6D. In this embodiment, the steering mechanism is disposed in a plane at a right angle to that in the first embodiment. The controlling means 3 in this embodiment engages a rotating bar 20 at one end 21, the rotating bar 20 being at a right angle to the controlling means 3. The end of the controlling means 21 is fixed with a fixing means such as a nut and bolt configuration 22 or other fixing means. Rotation of the controlling means with a handle 23 causes the fixed rotating bar 20 to rotate about the axis of the controlling means 20. The rotating bar 20 engages track rods 4 at pivot points 19 at the ends of the track rods proximal to the rotating bar. Preferably, the pivot points comprise of pivoting means such as nuts and bolts in rotatable configuration. Bars fixed to the wheels 2 engage the track rods at pivot points 24 at the distal end of the track rods 4. Movement of the rotating bar 20, and the partial rotation at the pivot points 19, 24, of the track rods and wheel bars 25 transfers energy along the members and cause the wheels to change their orientation simultaneously. FIGS. 6A and 6C show, from a top perspective, two orientations of the wheels caused by the rotation of the handle 23 at one position 6A and at another position 6B. FIGS. 6B and 6D show the configuration of the members from a side perspective. FIGS. 6A and 6B show two perspectives of the configuration of the members with the wheels in a first orientation, and FIGS. 6C and 6D show two perspectives of of the members with the wheels in a second orientation. The cooperation of the fixed handle of the controlling means 3, fixed rotating bar 20 in perpendicular orientation at the opposite end 21 of the controlling means to the handle 23, pivoting of the track bars 4 about pivot points at both ends 19, 24 and engagement with the wheel bars 25 transfers energy along the mechanism to cause the wheels 2 to rotate in the simultaneously in same direction. The loaded material to be transferred conveniently rests on the base plate 26. The base plate 26 is viewed from above in FIGS. 6A and 6C and from one side in FIGS. 6B and 6D. The base plate 26 may be larger or smaller than illustrated. Preferably, the base plate has a portion which rests on the floor when the trolley is not transporting loaded materials.

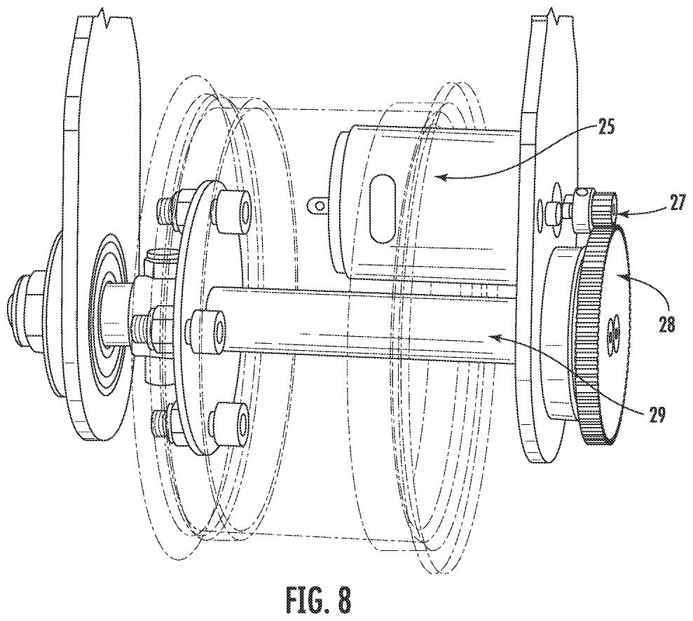

FIGS. 7 and 8 show an embodiment of the invention as shown in FIG. 6, but also incorporating a motor 25 for powering the movement of the trolley. There may be a motor at each of the trolley wheels. Only one motor is shown in this embodiment. The motor engages the wheel bracket 26. In operation the motor rotates a rod that penetrates the wheel bracket having a first gear 27 at its end on the opposite side of the wheel bracket. The first gear 27 engages a second gear 28 fixed at the end of the wheel axel 29 on the same side of the wheel bracket as the first gear. Operation of the motor and consequent rotation of the gears 27, 28 transfers the power from the motor to rotate the axel 29 of the wheel 29. Preferably the motor is an electric motor powered by a battery within the hub of the wheel. Preferably the battery is rechargeable.

1. Transporting apparatus for transporting materials or objects, including:
a frame;
a handle fixed to the frame;
an axle assembly;
wheels;
a base plate for supporting materials during transport;
a steering apparatus; and
a tiller arm for controlling the steering apparatus, the tiller arm spaced from the sides of the frame, and independently moveable from the frame, and pivotable about pivot points on the steering apparatus.

2. The transporting apparatus of claim 1, wherein the steering apparatus incorporates track rods pivotable about spaced pivot points on the tiller arm.

3. The transporting apparatus of claim 2 wherein the steering apparatus includes a rotating bar.

4. The transporting apparatus of claim 2 wherein the rotating bar engages the track rods.

5. The transporting apparatus of claim 4, further comprising of a clip to reversibly engage the tiller arm in reversible fixed engagement with the frame.

6. The apparatus of claim 4, further comprising of a motor for propulsion.

7. The apparatus of claim 5, further incorporating a bracket for the wheels and the wheel bracket engages the motor.

8. The apparatus of claim 6, where the motor is electric.

9. The apparatus of claim 8 where the electricity is provided by a battery.

10. The apparatus of claim 9, wherein the battery is rechargeable.
